(19) United States
(12) Patent Application Publication
(10) Pub. No.: US 2004/0248437 A1
(43) Pub. Date: Dec. 9, 2004

(54) Reinforced substrates having edge-mount connectors

(76) Inventor: Marvin Glenn Wong, Woodland Park, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/453,119

(22) Filed: Jun. 3, 2003

(51) Int. Cl. H01R 12/00

(52) U.S. Cl. 439/79

(57) ABSTRACT

Devices and methods are disclosed for reinforcing substrates having edge-mount connectors. In one embodiment, the device comprises a fragile substrate, a reinforcement plate bonded to the substrate, and an edge-mount connector mated with the substrate and the reinforcement plate.

### BACKGROUND OF THE INVENTION

Connectors are used to route power, ground, and signals, to and from electrical circuits on a substrate. Sometimes, the substrates used may be made of a fragile material, such as thin ceramic. Attaching a connector to such a substrate may cause the substrate to break. Assuming that the connector is successfully attached to the substrate, the stress of attaching a cable to a conventional connector may also cause the substrate to break.

Specific connectors may be tooled that have a larger attachment to the substrate, which may prevent the substrate from breaking. However, this may be prohibitively expensive due to the large number of different connector versions within a connector type that may be required for the different types of circuit layouts and products that may be added to the substrate. The expense of tooling specific connectors may be further increased by other requirements, such as minimizing size and the need for high frequency signal integrity, which may limit acceptable connector locations within a circuit and the type and nearness of surrounding circuit elements.

### SUMMARY OF THE INVENTION

Devices and methods are disclosed for reinforcing fragile substrates having edge-mount connectors. In one embodiment, a device is disclosed comprising a fragile substrate. The fragile substrate is bonded to a reinforcement plate. An edge-mount connector is mated with the substrate and the reinforcement plate.

### BRIEF DESCRIPTION OF THE DRAWINGS

Illustrative and presently preferred embodiments of the invention are illustrated in the drawings in which:

FIG. 1 illustrates a top view of a first exemplary device comprising a reinforced substrate and an edge-mount connector;

FIG. 2 illustrates a side view of the device shown in FIG. 1;

FIG. 3 illustrates a bottom view of the device shown in FIGS. 1 and 2;

FIG. 4 illustrates a side view of a second exemplary device comprising a reinforced substrate and an edge-mount connector;

FIG. 5 illustrates a bottom view of the device shown in FIG. 4; and

FIG. 6 is a flow diagram illustrating an exemplary method that may be used to construct the devices shown in FIGS. 1-5.

### DETAILED DESCRIPTION

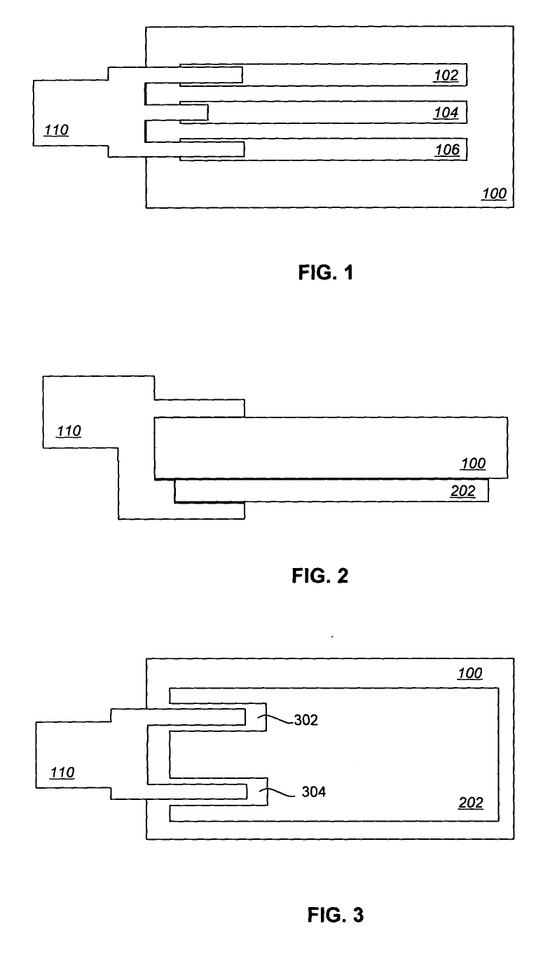

FIGS. 1-3 illustrate a reinforced substrate having an edge-mount connector. A substrate 100 is shown. By way of example, the substrate may be a fragile substrate, such as a thin ceramic substrate. Substrate 100 includes circuitry with two ground traces 102, 106 and one signal trace 104. It should be appreciated that in alternate embodiments, substrate 100 may include additional circuitry or circuitry different than that depicted in FIG. 1 (including various combinations of power, ground, or signal traces, as well as attached circuit components). Additionally, it should be appreciated that the ground traces 102, 106 and/or the signal trace 104 may not run the entire length of substrate 100.

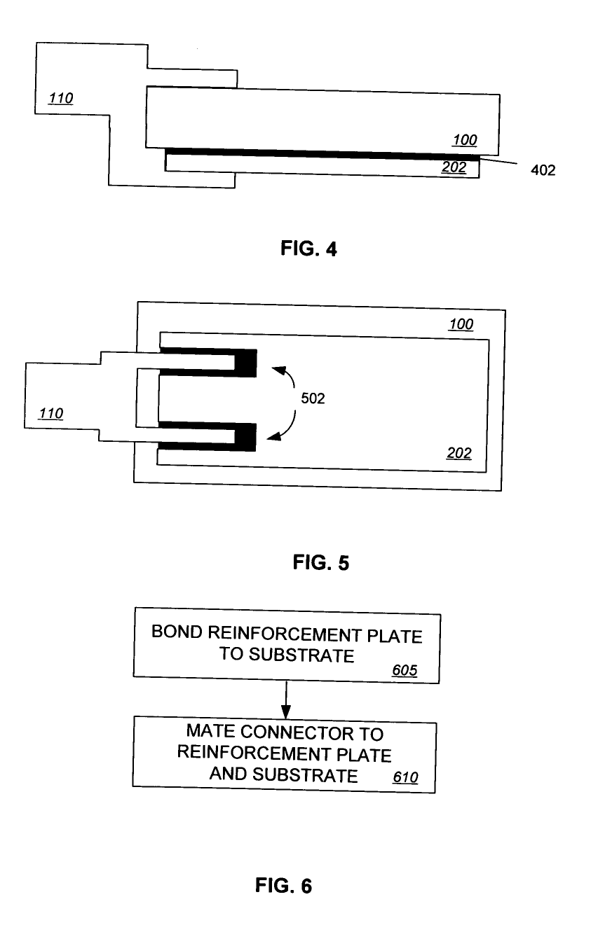

Reinforcement plate 202 (e.g., plated and/or stamped metal) is bonded to substrate 100. As shown in FIG. 4, in one embodiment, reinforcement plate 202 may be bonded to substrate 100 with solder 402. Alternately, reinforcement plate 202 may be bonded to substrate 100 with adhesive or another bonding material. Reinforcement plate 202 may be rectangular, square, or another shape and preferably covers substantially all of one surface of the substrate 100. However, in alternate embodiments, reinforcement plate may cover a smaller area of the substrate 100. It should be appreciated that reinforcement plate 202 may diffuse forces on the fragile substrate 100 caused by mating a cable with connector 110.

An edge-mount connector 110 is mated with the substrate 100 and the reinforcement plate 202. Edge-mount connector 110 may be one-piece or it may be made up of multiple components. It may be used to connect the ground traces 102, 106 and the signal trace 104 of substrate 100 to a cable inserted into edge-mount connector 110.

In one embodiment, reinforcement plate 202 may define notches 302, 304 to receive edge-mount connector 110, and edge-mount connector 110 may be connected to reinforcement plate 202 using a bonding material, such as solder or adhesive or another bonding material. It should be appreciated that alternate embodiments may not include notches. Other features, such as grooves or ridges, may be used to mate reinforcement plate 202 to edge-mount connector 110. Alternately, reinforcement plate 202 may not include any features to mate with edge-mount connector 110.

As shown in FIG. 5, reinforcement plate 202 may be grounded to the edge-mount connector by using a conductive adhesive or solder 502 to electrically couple reinforcement plate 202 to edge-mount connector 110. This may cause the reinforcement plate 202 to act as a ground plane for the circuitry 104.

FIG. 6 illustrates an exemplary method that may be used to reinforce fragile substrates with edge-mount connectors. A device may be produced by bonding 605 reinforcement plate 202 to substrate 100. By way of example, the reinforcement plate 202 may be bonded to substrate 100 using solder or adhesive. The reinforcement plate 202 may include notches 302, 304 to receive an edge-mount connector 110, but need not. The edge-mount connector 110 is mated to the substrate 100 and the notches 302, 304 on the reinforcement plate 202. In one embodiment, reinforcement plate 202 may be grounded to edge-mount connector 110 by using solder 502 or conductive adhesive to bond reinforcement plate 202 to edge-mount connector 110.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A device comprising:
a fragile substrate;
a reinforcement plate bonded to the substrate; and
an edge-mount connector mated with the substrate and the reinforcement plate.

2. The device of claim 1, wherein the reinforcement plate defines notches for receiving the edge-mount connector.

3. The device of claim 1, wherein the fragile substrate comprises a ceramic substrate.

4. The device of claim 1, wherein the fragile substrate includes a signal trace and one or more ground traces and the edge-mount connector is connected to the signal trace and the ground traces.

5. The device of claim 1, further comprising adhesive to adhere the reinforcement plate to the edge-mount connector.

6. The device of claim 5, wherein the adhesive comprises a conductive adhesive.

7. The device of claim 1, further comprising solder to solder the reinforcement plate to the edge-mount connector.

8 The device of claim 1, wherein the reinforcement plate is grounded to the edge-mount connector.

9. The device of claim 1, further comprising adhesive to bond the fragile substrate to the reinforcement plate.

10. The device of claim 1, further comprising solder to bond the fragile substrate to the reinforcement plate.

11. The device of claim 1, wherein the reinforcement plate comprises a plated metal.

12. A method for enforcing a fragile substrate, the method comprising:
bonding a reinforcement plate to the fragile substrate, the reinforcement plate including notches to receive an edge-mount connector; and
mating the edge-mount connector to the notches on the reinforcement plate, and to the fragile substrate.

13. The method of claim 12, wherein mating comprises soldering the reinforcement plate to the edge-mount connector.

14. The method of claim 12, wherein mating comprises applying an adhesive to at least one of the reinforcement plate and the edge-mount connector, and adhering the reinforcement plate to the edge-mount connector.

15. The method of claim 14, wherein the adhesive comprises a conductive adhesive.

16. The method of claim 12, wherein the substrate comprises a ceramic substrate.

17. A device comprising:
a ceramic substrate;
a reinforcement plate bonded to the ceramic substrate, the reinforcement plate having notches to receive an edge-mount connector; and
an edge-mount connector inserted into the notches and electrically coupled to the reinforcement plate.

18. The device of claim 17, wherein the reinforcement plate is electrically coupled to the edge-mount connector with a conductive adhesive.

19. The device of claim 17, wherein the reinforcement plate is electrically coupled to the edge-mount connector with solder.

20. The device of claim 17, wherein the reinforcement plate comprises a plated metal.
